(19) United States
(12) Patent Application Publication
(10) Pub. No.: US 2025/0314824 A1
(43) Pub. Date: Oct. 9, 2025

(54) HETEROGENEOUS BONDED OPTICAL WAVEGUIDE SHEET

(71) Applicant: MOLDNANO (HANGZHOU) TECHNOLOGY CO., LTD., Hangzhou (CN)

(72) Inventors: Kaikai DU, Hangzhou (CN); Xing CHEN, Hangzhou (CN); Lu CAI, Hangzhou (CN)

(73) Assignee: MOLDNANO (HANGZHOU) TECHNOLOGY CO., LTD., Hangzhou (CN)

(21) Appl. No.: 19/091,891

(22) Filed: Mar. 27, 2025

Related U.S. Application Data
(63) Continuation-in-part of application No. PCT/CN2024/128110, filed on Oct. 29, 2024.

(30) Foreign Application Priority Data
Apr. 8, 2024 (CN) 202410412310.8

(51) Int. Cl. G02B 6/13; G02B 6/12; G02B 6/122

(52) U.S. Cl. CPC G02B 6/13; G02B 6/1223; G02B 2006/12038; G02B 2006/12061; G02B 2006/12107; G02B 2006/12169

(57) ABSTRACT

Disclosed is a heterogeneous bonded optical waveguide sheet. The heterogeneous bonded optical waveguide sheet comprises an optical waveguide layer composed of a wide bandgap semiconductor material, and a glass substrate composed of high refractive index glass. The optical waveguide layer is disposed on the glass substrate, and a surface of the optical waveguide layer away from the glass substrate is provided with a grating structure. The heterogeneous bonded optical waveguide sheet solves the problems that the refractive index of the current high refractive index glass optical wave sheet reaches a bottleneck (around 2.0) and stray light is caused by secondary coupling-out, and has the advantages of high refractive index, large FOV, full-color display on a single sheet, and reducing rainbow artifacts.

### CROSS-REFERENCE TO RELATED APPLICATIONS

This application is a Continuation-in-part of International Application No. PCT/CN2024/128110, filed on Oct. 29, 2024, which claims priority to Chinese Patent Application No. 202410412310.8, filed on Apr. 8, 2024, the entire contents of each of which are hereby incorporated by reference.

### TECHNICAL FIELD

The present disclosure relates to the technical field of optical components, and in particular to a heterogeneous bonded optical waveguide sheet.

### BACKGROUND

Augmented Reality (AR) technology is a technology that provides users with virtual information through images, videos, 3D models, and other techniques while displaying real scenes, achieving ingenious integration of virtual information with the real world. AR technology is poised to become the next breakthrough in information technology, and AR glasses may replace smartphones as the next-generation collaborative computing platform. AR technology, represented by AR glasses, is now gaining traction across various industries, particularly in the fields of security and industry, where AR technology demonstrates unparalleled advantages and significantly improves the way of information interaction. At present, relatively mature optical display solutions in AR technology mainly include a prism solution, a birdbath solution, a free-form surface solution, an off-axis holographic lens solution, and a waveguide solution.

Among the various optical display solutions, a surface relief grating (SRG) waveguide, which uses a surface relief grating (SRG) instead of a traditional reflective optical element (ROE) as a coupling-in, coupling-out, and exit pupil expander (EPE) in the waveguide solution, is considered the most promising implementation for consumer-grade AR glasses due to its excellent performance. The gratings on the waveguide are designed for the wavelengths of red, green, or blue light within a visible spectrum to enable virtual images or information to be coupled into or decoupled out of an optical waveguide, making the images visible to eyes. If a glass substrate used as the waveguide has a high refractive index, the optical performance of the AR glasses is typically determined by a minimum refractive index of the optical waveguide sheet, i.e., the refractive index of the glass substrate in a red spectral range. Such high refractive index glass facilitates total reflection of light within the waveguide, thereby reducing light leakage losses, reducing rainbow artifacts, and ultimately improving field of view (FOV), optical clarity, and light transmission efficiency.

Existing high refractive index glass materials are relatively brittle. The inclusion of heavy glass components (i.e., components with a high molar mass) helps improve the refractive index and mechanical reliability of the glass substrate, while increasing the weight of the glass substrate in a wearing state and the production cost. Meanwhile, the refractive index of the current high refractive index glass reaches a bottleneck (around 2.0), and issues such as stray light caused by secondary coupling-out due to the high refractive index persist, which limits the improvement of the optical performance of AR lenses.

Therefore, it is desirable to provide a heterogeneous bonded optical waveguide sheet, which has the advantages of the high refractive index, large FOV, and reducing rainbow artifacts, and also achieves full-color display on a single sheet and avoids stray light caused by secondary coupling-out.

### SUMMARY

The problem to be solved by the present disclosure is to provide, in response to the above deficiencies in the prior art, a heterogeneous bonded optical waveguide sheet, which solves the problems that the refractive index of the current high refractive index glass optical wave sheet reaches a bottleneck (around 2.0) and stray light is caused by secondary coupling-out, and has the advantages of high refractive index, large FOV, full-color display on a single sheet, and reducing rainbow artifacts.

One or more embodiments of the present disclosure provide a heterogeneous bonded optical waveguide sheet. The heterogeneous bonded optical waveguide sheet may comprise an optical waveguide layer composed of a wide bandgap semiconductor material, and a glass substrate composed of high refractive index glass. The optical waveguide layer may be disposed on the glass substrate, and a surface of the optical waveguide layer away from the glass substrate may be provided with a grating structure.

In some embodiments, a refractive index of the optical waveguide layer may be greater than 2.60.

In some embodiments, the optical waveguide layer may be composed of a silicon carbide material.

In some embodiments, a thickness of the optical waveguide layer may be in a range of 0.10 mm-0.20 mm.

In some embodiments, the grating structure may be a subwavelength grating structure composed of at least one of a plurality of straight-edged gratings, slanted-edged gratings, or a plurality of blazed gratings arranged in a one-dimensional array or two-dimensional array.

In some embodiments, a refractive index of the glass substrate may be in a range of 1.50-1.90.

In some embodiments, a thickness of the glass substrate may be in a range of 0.30 mm-0.80 mm.

In some embodiments, the optical waveguide layer may be provided on the glass substrate by at least one of direct bonding, thermal compression bonding, or optical bonding.

In some embodiments, a bonding process of the optical waveguide layer and the glass substrate may include: performing plasma activation treatment on bonding surfaces of the optical waveguide layer and the glass substrate, respectively; stacking the optical waveguide layer and the glass substrate in a manner that the bonding surfaces are opposite each other; and performing bonding treatment and annealing treatment on the optical waveguide layer and the glass substrate after stacking in sequence to form a Si—O—Si bonding surface between the optical waveguide layer and the glass substrate, so as to obtain the heterogeneous bonded optical waveguide sheet.

In some embodiments, during the bonding treatment, the bonding process of the optical waveguide layer and the glass substrate may be completed in a manner from a center to an edge.

In some embodiments, a temperature during the annealing treatment may be controlled to be in a range of 200° C.-400° C., and an annealing time may be in a range of 1 h-3 h.

In some embodiments, before the plasma activation treatment is performed, the wide bandgap semiconductor material and the high refractive index glass may be cleaned and blown dry using nitrogen gas, respectively, to obtain the optical waveguide layer and the glass substrate.

In some embodiments, during the plasma activation treatment, a flow rate of plasma may be controlled to be in a range of 15 sccm-25 sccm, a power may be in a range of 80 W-120 W, and an activation treatment time may be in a range of 50 s-70 s.

The embodiments of the present disclosure include but are not limited to the following beneficial effects.

If the silicon carbide or the high refractive index glass is used alone as the material for the optical waveguide sheet, a total reflection path within the optical waveguide sheet is relatively short as the thickness of the optical waveguide sheet decreases and the refractive index increases, which leads to a plurality of reflections onto a coupling grating, increasing the probability of secondary coupling-out and causing more stray light. To achieve the purpose of thinning the optical waveguide sheet and improving the high refractive index, while avoiding drawbacks caused by the improvement, the embodiments of the present disclosure adopt a silicon carbide optical waveguide layer bonded to a high refractive index glass substrate, and integrate the grating structure on the silicon carbide optical waveguide layer, which increases a lateral transmission distance of small-angle diffracted light, reduces secondary diffraction of light, and avoids stray light.

The embodiments of the present disclosure achieve full-color display using a single optical waveguide sheet, which increases the lateral transmission distance of the small-angle diffracted light, and reduces a color difference caused by the secondary diffraction of light. According to a grating equation

$$n \times d \times sin θ = k \times λ , sin θ = \frac{k \times λ}{n \times d} , \\ sin θ R - sin θ G = \frac{k \times ( λ R - λ G )}{n \times d} , Δ θ = \frac{k \times Δ λ}{n \times d} ,$$

n denotes a refractive index of a medium, θ denotes a diffraction angle, θR and θG denote diffraction angles of red light and green light, respectively, λ denotes a wavelength of an incident wave, d denotes a grating constant, and k denotes a diffraction order. Accordingly, for the same light transmission, the greater the refractive index, the smaller the difference in the diffraction angle, such that the color difference is decreased by using the high refractive index optical waveguide layer.

The embodiments of the present disclosure adopt the silicon carbide material with a refractive index above 2.6 bonded to the high refractive index glass with a refractive index above 1.5, which enables the optical waveguide sheet to break through the bottleneck of the refractive index of 2.0, thereby increasing a bending angle of the light propagating within the optical waveguide sheet, and ultimately improving the FOV and reducing the range of external stray light affected by the rainbow artifacts.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating an exemplary heterogeneous bonded optical waveguide sheet according to some embodiments of the present disclosure;

FIG. 2 is a flowchart illustrating an exemplary bonding process of an optical waveguide layer and a glass substrate according to some embodiments of the present disclosure; and

FIG. 3 is a schematic structural diagram illustrating an exemplary process of determining a total reflection distance according to some embodiments of the present disclosure.

Reference signs: 1, optical waveguide layer; 11, grating structure; 2, glass substrate.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

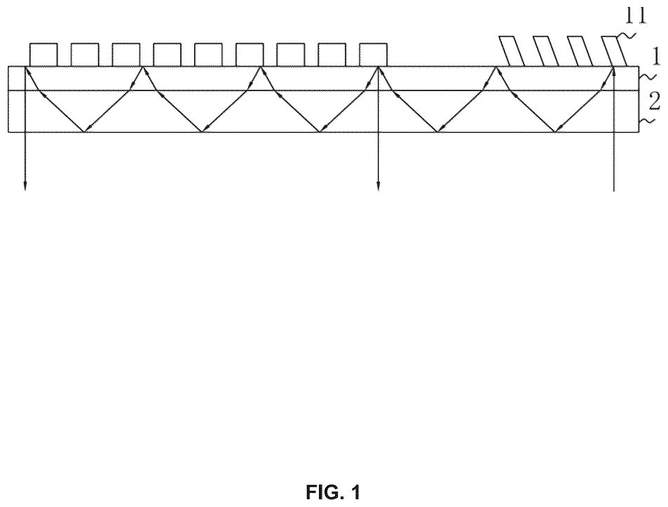

FIG. 1 is a schematic structural diagram illustrating an exemplary heterogeneous bonded optical waveguide sheet according to some embodiments of the present disclosure.

In some embodiments, as shown in FIG. 1, the heterogeneous bonded optical waveguide sheet disclosed in the embodiments of the present disclosure may include an optical waveguide layer 1 composed of a wide bandgap semiconductor material, and a glass substrate 2 composed of high refractive index glass. The optical waveguide layer 1 may be disposed on the glass substrate 2, and a surface of the optical waveguide layer 1 away from the glass substrate 2 may be provided with a grating structure 11.

According to the embodiments of the present disclosure, the optical waveguide sheet has the advantages of high refractive index, large FOV, full-color display on a single sheet, and reducing rainbow artifacts, as described below.

According to the optical waveguide sheet of the present disclosure, the wide bandgap semiconductor material refers to a semiconductor material with a bandgap width of 2.3 eV or more. For example, the wide bandgap semiconductor material may include, but is not limited to, one or more of silicon carbide (4H-SiC, 6H-SiC, 3C-SiC), gallium nitride (GaN), zinc oxide (ZnO), aluminum nitride (AlN), zinc selenide (ZnSe), indium gallium zinc oxide (IGZO), and diamond, or any combination thereof.

The optical waveguide layer is a core component of the optical waveguide sheet that limits the propagation of light within a specific dielectric layer to achieve efficient optical transmission and regulation.

In some embodiments, a refractive index of the optical waveguide layer may be greater than 2.60. In some embodiments, the refractive index of the optical waveguide layer may be 2.60. In some embodiments, the refractive index of the optical waveguide layer may be 2.65. In some embodiments, the refractive index of the optical waveguide layer may be 2.70.

In the embodiments of the present disclosure, the greater the refractive index, the smaller the difference in the diffraction angle, such that the color difference is decreased by using the high refractive index optical waveguide layer. Meanwhile, the high refractive index optical waveguide layer may also have a stronger light limiting capability and higher light transmission efficiency, thereby reducing light leakage while minimizing bending and scattering loss.

In some embodiments, the optical waveguide layer may be composed of a silicon carbide material. For example, the silicon carbide material may include 3C-SiC, 4H-SiC, 6H-SiC, a-SiC, etc.

The silicon carbide material has a high refractive index range and demonstrates high transparency from visible to near-infrared wavelength ranges, and has high thermal conductivity, high temperature stability, chemical stability, and high mechanical strength. Accordingly, in the embodiments of the present disclosure, the optical waveguide layer composed of the silicon carbide material can improve the durability of the optical waveguide sheet, reduce the optical loss, improve the light transmission efficiency, and also be suitable for a harsh environment or a high temperature environment.

In some embodiments, a thickness of the optical waveguide layer may be in a range of 0.10 mm-0.20 mm. In some embodiments, the thickness of the optical waveguide layer may be 0.10 mm. In some embodiments, the thickness of the optical waveguide layer may be 0.12 mm. In some embodiments, the thickness of the optical waveguide layer may be 0.15 mm. In some embodiments, the thickness of the optical waveguide layer may be 0.17 mm. In some embodiments in, the thickness of the optical waveguide layer may be 0.20 mm.

In the embodiments of the present disclosure, the optical waveguide layer with an appropriate thickness can effectively reduce the light scattering and absorption loss, improve the light transmission efficiency, enhance the light limiting capability, and reduce light leakage.

The grating structure refers to a structure composed of a plurality of parallel slits of equal width and equal spacing. For example, the grating structure may include, but is not limited to, a transmission grating or a reflection grating.

In some embodiments, the grating structure may be a sub-wavelength grating structure composed of at least one of a plurality of straight-edged gratings, a plurality of slanted-edged gratings, or a plurality of blazed gratings arranged in a one-dimensional array or a two-dimensional array.

The straight-edged grating refers to a grating structure composed of a series of parallel straight grooves with equal spacing, a groove direction being perpendicular to a grating surface. The slanted-edged grating refers to a grating structure in which grooves are arranged at a certain inclined angle relative to the grating surface. The blazed grating refers to a grating structure composed of serrated grooves.

The glass substrate refers to a support material in the optical waveguide sheet, and is configured to carry the optical waveguide layer to provide mechanical stability and optical performance. The glass substrate has excellent corrosion resistance and weather resistance, so as to protect the optical waveguide layer from environmental erosion.

The high refractive index glass refers to glass with a refractive index of 1.50 or more. For example, the high refractive index glass may include, but is not limited to, silicate, borate, phosphate, fluoride, and sulfur compound series glass, or high refractive index dielectric materials thereof doped with titanium oxide, zirconium oxide, zinc oxide, alumina, etc.

In some embodiments, a refractive index of the glass substrate may be in a range of 1.50-1.90. In some embodiments, the refractive index of the glass substrate may be 1.50. In some embodiments, the refractive index of the glass substrate may be 1.60. In some embodiments, the refractive index of the glass substrate may be 1.65. In some embodiments, the refractive index of the glass substrate may be 1.70. In some embodiments, the refractive index of the glass substrate may be 1.80. In some embodiments, the refractive index of the glass substrate may be 1.90.

In the embodiments of the present disclosure, the glass substrate with the refractive index within the above range allows for well matching with the refractive index of the optical waveguide layer, thereby reducing interface reflection and mismatch of the refractive index. Meanwhile, the glass substrate with the refractive index in the range of 1.50-1.90 has high transparency and low optical loss, significantly reducing the light transmission loss. The glass substrate with the high refractive index also supports a relatively small bending radius, thereby reducing the bending loss.

In some embodiments, a thickness of the glass substrate may be in a range of 0.30 mm-0.80 mm. In some embodiments, the thickness of the glass substrate may be 0.30 mm. In some embodiments, the thickness of the glass substrate may be 0.40 mm. In some embodiments, the thickness of the glass substrate may be 0.50 mm. In some embodiments, the thickness of the glass substrate may be 0.55 mm. In some embodiments, the thickness of the glass substrate may be 0.60 mm. In some embodiments, the thickness of the glass substrate may be 0.70 mm. In some embodiments, the thickness of the glass substrate may be 0.80 mm.

In the embodiments of the present disclosure, the glass substrate with an appropriate thickness is less prone to bending or deformation, and can maintain the shape stability of the optical waveguide sheet. In addition, the glass substrate with an appropriate thickness can provide homogeneous optical performance, thereby reducing the inhomogeneity in an optical path, and improving the light transmission efficiency.

In some embodiments, the optical waveguide layer may be provided on the glass substrate by at least one of f direct bonding, thermal compression bonding, or optical bonding.

The direct bonding refers to a process of bonding two surfaces through a van der Waals force, hydrogen bonds, or chemical bonds without using an intermediate adhesive. The thermal compression bonding refers to a process of bonding two surfaces under the condition of heating (e.g., heating to a temperature of 200° C.-400° C.) and applying a pressure (e.g., applying a pressure of 1 MPa-10 MPa). The optical bonding refers to a process of bonding by filling a transparent optical adhesive (e.g., epoxy or silicone) between two layers of materials.

In some embodiments, the optical waveguide layer may be provided on the glass substrate by the direct bonding. In the embodiments of the present disclosure, the optical waveguide layer may be provided on the glass substrate by the direct bonding in a way of forming strong bonding through interaction between surface molecules, so as to resist to humidity, temperature change, and chemical corrosion, thereby improving the reliability and durability of the optical waveguide sheet. Meanwhile, interfaces of the direct bonding do not rely on an adhesive or an intermediate layer, which realizes high-precision alignment and reduces thermal stress.

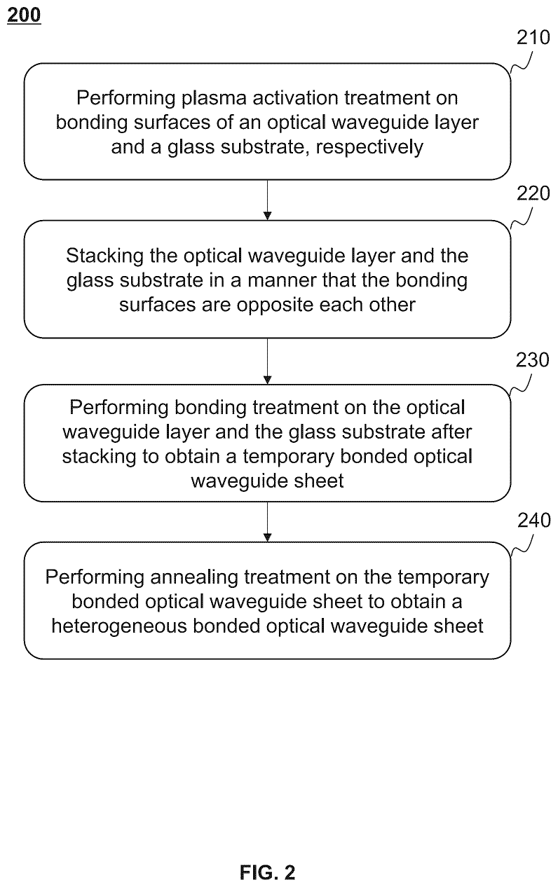

More descriptions regarding the bonding process may be found in FIG. 2 and the related descriptions thereof.

In the embodiments of the present disclosure, the silicon carbide optical waveguide layer is bonded to the glass substrate with the high refractive index, and the grating structure is integrated on the silicon carbide optical waveguide layer, which increases a lateral transmission distance of small-angle diffracted light, reduces secondary diffraction of light, and avoids stray light. The silicon carbide material with a refractive index above 2.6 bonded to the high refractive index glass with a refractive index above 1.5 is adopted, which enables the optical waveguide sheet to break through the bottleneck of the refractive index of 2.0, thereby increasing the bending angle of the light propagating within the optical waveguide sheet, and ultimately improving the FOV and reducing the range of external stray light affected by the rainbow artifacts.

FIG. 2 is a flowchart illustrating an exemplary bonding process of an optical waveguide layer and a glass substrate according to some embodiments of the present disclosure.

As shown in FIG. 2, a process 200 may include the following operations.

In some embodiments, an operator or a robotic arm may perform plasma activation treatment on bonding surfaces of the optical waveguide layer and the glass substrate, respectively; stack the optical waveguide layer and the glass substrate in a manner that the bonding surfaces are opposite each other; and perform bonding treatment and annealing treatment on the optical waveguide layer and the glass substrate after staking in sequence to form a Si—O—Si bonding surface between the optical waveguide layer and the glass substrate, so as to obtain a heterogeneous bonded optical waveguide sheet.

In 210, plasma activation treatment may be performed on bonding surfaces of an optical waveguide layer and a glass substrate, respectively.

The plasma activation treatment refers to a process of bombarding the surfaces of the optical waveguide layer and the glass substrate with plasma to induce chemical reactions or physical modifications so as to increase surface activity and adhesion property.

In some embodiments, before the plasma activation treatment is performed, a wide bandgap semiconductor material and high refractive index glass may be cleaned and blown dry using nitrogen gas, respectively, to obtain the optical waveguide layer and the glass substrate.

In some embodiments, the wide bandgap semiconductor material and the high refractive index glass may be cleaned using RCA Standard Clean.

In some embodiments, the wide bandgap semiconductor material and the high refractive index glass may be placed with the bonding surfaces facing upward and cleaned to obtain the optical waveguide layer and the glass substrate.

In the embodiments of the present disclosure, the optical waveguide layer and the glass substrate are cleaned before the plasma activation treatment, which can remove organic contaminants, particles, and metallic impurities from the surface, and guarantee surface cleanliness. Meanwhile, the cleaned surfaces are more easily activated by the plasma, which helps to form a stronger bonding interface.

The bonding surface refers to a surface where two or more material surfaces are bonded together by physical or chemical action during the bonding process. In some embodiments, the bonding surfaces of the optical waveguide layer and the glass substrate may be pre-specified.

In some embodiments, during the plasma activation treatment, a flow rate of the plasma may be controlled to be in a range of 15 sccm-25 sccm, a power may be in a range of 80 W-120 W, and an activation treatment time may be in a range of 50 s-70 s.

For example, the surfaces of the optical waveguide layer and the glass substrate are bombarded by the plasma (e.g., oxygen), respectively, and the flow rate of the plasma (e.g., oxygen) is controlled to be 20 sccm, the power is 100 W, and the activation treatment time is 60 s. The plasma activation treatment activates Si—O bonds on the surfaces of the optical waveguide layer and the glass substrate, making the surfaces hydrophilic. In some embodiments, the plasma may include, but is not limited to, one or more of oxygen (O₂), nitrogen (N₂), argon (Ar), hydrogen (H₂), or the like, or any mixture thereof.

In the embodiments of the present disclosure, an appropriate flow rate of plasma guarantees a uniform gas distribution, which avoids being locally thick or thin, and improves the uniformity of surface activation. An appropriate power can effectively excite the plasma to generate sufficient active particles (e.g., free radicals and ions) to activate the surface, while setting sufficient treatment time to guarantee that the surface is sufficiently activated to form a high density of active groups, thereby significantly improving surface energy and enhancing chemical activity of the bonding interfaces.

In 220, the optical waveguide layer and the glass substrate may be stacked in a manner that the bonding surfaces are opposite each other.

In some embodiments, the bonding surfaces may be ensured to be clean, flat, and free of contaminants and particles (e.g., by cleaning and surface activation treatment) before stacking to improve the bonding effect. In some embodiments, the bonding surfaces may also be flattened before stacking to ensure the surface roughness.

In some embodiments, the bonding surfaces of the optical waveguide layer and the glass substrate may be aligned using a high-precision alignment device to ensure that the optical structure of the optical waveguide layer precisely matches the position of the glass substrate and avoid optical path offset. For example, the high-precision alignment device may include an optical alignment system, an infrared alignment system, a mechanical alignment system, a nanoimprint alignment system, etc.

In some embodiments, the bonding treatment and the annealing treatment may be performed on the optical waveguide layer and the glass substrate after stacking in sequence to form the Si—O—Si bonding surface between the optical waveguide layer and the glass substrate, so as to obtain the heterogeneous bonded optical waveguide sheet. The above process may include the bonding treatment in operation 230 and the annealing treatment in operation 240.

In 230, bonding treatment may be performed on the optical waveguide layer and the glass substrate after stacking to obtain a temporary bonded optical waveguide sheet.

In some embodiments, during the bonding treatment, the bonding process of the optical waveguide layer and the glass substrate may be completed in a manner from a center to an edge, and air between the optical waveguide layer and the glass substrate may be discharged, so as to obtain the temporary bonded optical waveguide sheet. The bonding surfaces between the optical waveguide layer and the glass substrate are rich in dioxygen bonds (═O bonds), which, combined with water vapor in the air, form hydroxyl bonds (—OH bonds). The van der Waals force of the hydrogen bonds causes the surfaces of the optical waveguide layer and the glass substrate to bond with each other, thereby obtaining temporary bonding with a certain strength.

In the embodiments of the present disclosure, the bonding process is completed in a manner from the center to the edge, which can gradually discharge gases and air from the center to the edge during the bonding process, and reduce formation of bubbles and voids. Meanwhile, the pressure is applied from the center to the edge, which guarantees uniform contact at the bonding interfaces and avoid local unbonded regions. Accordingly, the embodiment can effectively reduce bubbles, stress concentration, and interface defects, thereby improving the bonding quality and performance of the optical waveguide sheet.

In 240, annealing treatment may be performed on the temporary bonded optical waveguide sheet to obtain a heterogeneous bonded optical waveguide sheet.

The annealing treatment refers to a thermal treatment that removes internal stress, optimizes the structure, and improves material performance by heating the optical waveguide layer and the glass substrate to a specific temperature, maintaining for a period of time, and then cooling slowly.

In some embodiments, a temperature during the annealing treatment may be controlled to be in a range of 200° C.-400° C., and an annealing time may be in a range of 1 h-3 h. For example, the temperature during the annealing treatment is 300° C., and the annealing time is 2 h.

In some embodiments, the annealing treatment may be performed on the temporary bonded optical waveguide sheet, the temperature may be controlled to be in a range of 200° C.-400° C., the annealing time may be in a range of 1 h-3 h, so as to obtain the heterogeneous bonded optical waveguide sheet. The annealing treatment can reduce the —OH bonds of the bonding surfaces to water molecules to form the Si—O—Si bonding surface with a stronger bonding force, and discharge the water vapor to achieve transformation of the van der Waals force to covalent bonds, thereby significantly increasing the bonding strength between the optical waveguide layer and the glass substrate.

In the embodiments of the present disclosure, an appropriate annealing temperature and annealing time can promote interfacial atomic diffusion, ensure sufficient interfacial reaction, significantly improve the bonding strength, eliminate interfacial stress, and improve the performance of the optical waveguide sheet.

In the embodiments of the present disclosure, polar groups (e.g., —OH, and —COOH) are introduced by the plasma activation treatment, which can significantly increase the surface energy of the optical waveguide layer and the glass substrate and enhance the chemical activity of the bonding interfaces. The bonding treatment can form strong bonding at the interface, and the annealing treatment can further promote the interfacial atomic diffusion and chemical reaction, thereby enhancing the bonding strength. The bonding process between the optical waveguide layer and the glass substrate is achieved by the plasma activation treatment, the stacking, the bonding treatment, and the annealing treatment, which can enhance the bonding strength, reduce the optical loss, improve the light transmission efficiency between the optical waveguide layer and the glass substrate, improve the thermal stability of the bonding interfaces, enhance the environmental adaptability, and reduce maintenance and replacement cost.

It should be noted that the foregoing description of the process 200 is for the purpose of exemplification and illustration only, and does not limit the scope of application of the present disclosure. For those skilled in the art, various corrections and changes can be made to the process 200 under the guidance of the present disclosure. However, these corrections and changes remain within the scope of the present disclosure.

In some embodiments, the heterogeneous bonded optical waveguide sheets composed of optical waveguide layers of different thicknesses and glass substrates of different refractive indices are tested, and test results are shown in Table 1 below.

TABLE 1

| | Thickness of | | Refractive | | | | | |
|---|---|---|---|---|---|---|---|---|
| | the optical | | index of | Thickness of | | | Total | |
| | waveguide | | the glass | the glass | | | reflection | |
| | layer | | substrate | substrate | | FOV | distance | |
| Example 1 | 0.1 | mm | 1.8 | 0.4 | mm | 82° | 0.67 | mm |
| Example 2 | 0.15 | mm | 1.8 | 0.35 | mm | 82° | 0.64 | mm |
| Example 3 | 0.2 | mm | 1.8 | 0.3 | mm | 82° | 0.61 | mm |
| Example 4 | 0.15 | mm | 1.5 | 0.35 | mm | 82° | 0.83 | mm |
| Example 5 | 0.15 | mm | 1.6 | 0.35 | mm | 82° | 0.75 | mm |
| Example 6 | 0.15 | mm | 1.7 | 0.35 | mm | 82° | 0.69 | mm |
| Contrast | 0 | mm | 1.8 | 0.5 | mm | 25° | 0.67 | mm |
| Example 1 | | | | | | | | |
| Contrast | 0.5 | mm | 1.8 | 0 | mm | 82° | 0.40 | mm |
| Example 2 | | | | | | | | |

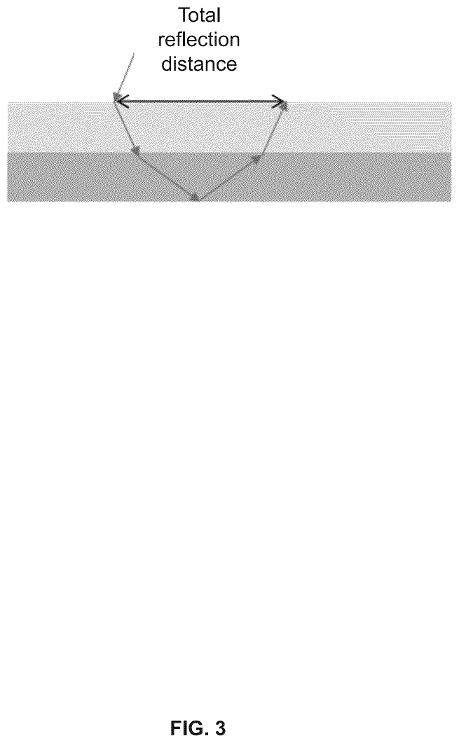

FIG. 3 is a schematic structural diagram illustrating an exemplary process of determining a total reflection distance according to some embodiments of the present disclosure. In some embodiments, as shown in FIG. 3, the process of determining the total reflection distance may include: uniformly determining incident light as −30°, a grating period being P=300 nm, and a wavelength being λ=456 nm (B). A corresponding diffraction angle in SiC is determined to be 23.2°, and corresponding diffraction angles in high refractive index glass at different refractive indices are determined according to a grating equation. The greater the total reflection distance, the smaller the effect of secondary diffraction, and the higher the corresponding efficiency under the same condition.

According to Table 1, if only glass with a refractive index of 1.8 is used as the optical waveguide sheet, the FOV is 25° (very small); if only a SiC material is used as the optical waveguide sheet, the total reflection distance is very small, the effect of secondary diffraction is high, the optical effect loss is high, and the visual performance for the human eyes is poor. By combining the SiC with different thicknesses and the high refractive index glass with different parameters, if the grating structure 11 uses the SiC, the FOV can be increased to 82°. In addition, the refractive index of lenses increases, the FOV increases, and the angel at which rainbow artifacts are caused decreases (i.e., the effect of the rainbow artifacts is reduced).

Finally, the above embodiments are only used to illustrate the technical solutions of the present disclosure and are not limiting. Although the present disclosure is described in detail with reference to the preferred embodiments, those skilled in the art should understand that the technical solutions of the present disclosure may be modified or equivalently replaced without departing from the purpose and scope of the technical solutions of the present disclosure, all of which should be within the scope of the claims of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about,” “approximately,” or “substantially” in some examples. Unless otherwise stated, “about,” “approximately,” or “substantially” indicates that the number is allowed to vary by +20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A heterogeneous bonded optical waveguide sheet, comprising: an optical waveguide layer composed of a wide bandgap semiconductor material, and a glass substrate composed of high refractive index glass; wherein
the optical waveguide layer is disposed on the glass substrate, and a surface of the optical waveguide layer away from the glass substrate is provided with a grating structure.

2. The heterogeneous bonded optical waveguide sheet of claim 1, wherein a refractive index of the optical waveguide layer is greater than 2.60.

3. The heterogeneous bonded optical waveguide sheet of claim 2, wherein the optical waveguide layer is composed of a silicon carbide material.

4. The heterogeneous bonded optical waveguide sheet of claim 3, wherein a thickness of the optical waveguide layer is in a range of 0.10 mm-0.20 mm.

5. The heterogeneous bonded optical waveguide sheet of claim 1, wherein the grating structure is a subwavelength grating structure composed of at least one of a plurality of straight-edged gratings, a plurality of slanted-edged gratings, or a plurality of blazed gratings arranged in a one-dimensional array or a two-dimensional array.

6. The heterogeneous bonded optical waveguide sheet of claim 1, wherein a refractive index of the glass substrate is in a range of 1.50-1.90.

7. The heterogeneous bonded optical waveguide sheet of claim 6, wherein a thickness of the glass substrate is in a range of 0.30 mm-0.80 mm.

8. The heterogeneous bonded optical waveguide sheet of claim 1, wherein the optical waveguide layer is provided on the glass substrate by at least one of direct bonding, thermal compression bonding, or optical bonding.

9. The heterogeneous bonded optical waveguide sheet of claim 8, wherein a bonding process of the optical waveguide layer and the glass substrate includes:
performing plasma activation treatment on bonding surfaces of the optical waveguide layer and the glass substrate, respectively;
stacking the optical waveguide layer and the glass substrate in a manner that the bonding surfaces are opposite each other; and
performing bonding treatment and annealing treatment on the optical waveguide layer and the glass substrate after stacking in sequence to form a Si—O—Si bonding surface between the optical waveguide layer and the glass substrate, so as to obtain the heterogeneous bonded optical waveguide sheet.

10. The heterogeneous bonded optical waveguide sheet of claim 9, wherein during the bonding treatment, the bonding process of the optical waveguide layer and the glass substrate is completed in a manner from a center to an edge.

11. The heterogeneous bonded optical waveguide sheet of claim 9, wherein a temperature during the annealing treatment is controlled to be in a range of 200° C.-400° C., and annealing time is in a range of 1 h-3 h.

12. The heterogeneous bonded optical waveguide sheet of claim 9, wherein the bonding process further includes:
before the plasma activation treatment is performed, the bandgap semiconductor materials and the high refractive index glass are cleaned and blown dry using nitrogen gas, respectively, to obtain the optical waveguide layer and the glass substrate.
